(19) United States
(12) Patent Application Publication
(10) Pub. No.: US 2026/0328967 A1
(43) Pub. Date: Oct. 22, 2026

(54) NEAR-INFRARED ABSORBING COMPOSITION, NEAR-INFRARED ABSORBING CURED FILM, AND OPTICAL MEMBER

(71) Applicant: Konica Minolta, Inc., Tokyo (JP)

(72) Inventors: Takayuki SUZUKI, Kokubunji-shi, Tokyo (JP); Natsumi KIRIISHI, Hino-shi, Tokyo (JP); Kaori ONO, Ichihara-shi, Chiba (JP)

(21) Appl. No.: 19/482,147

(22) PCT Filed: Apr. 22, 2024
(86) PCT No.: PCT/JP2024/015694

§ 371 Date: Nov. 6, 2025

(30) Foreign Application Priority Data
May 18, 2023 (JP) 2023-082047

(51) Int. Cl. G02B 1/04; C08K 5/00; C08K 5/521; C08K 5/5425; C09D 5/32; C09D 7/20; C09D 7/41; C09D 7/45; C09D 7/63; G02B 5/20

(52) U.S. Cl. CPC G02B 1/04; C09D 5/32; C09D 7/20; C09D 7/41; C09D 7/45; C09D 7/63; G02B 5/208; C08K 5/0091; C08K 5/521; C08K 5/5425; C08K 2201/014

(57) ABSTRACT

The present invention addresses the problem of providing: a near-infrared absorbing composition capable of forming a cured film having excellent storage stability and humidity and heat resistance; and a near-infrared absorbing cured film and an optical member in which the near-infrared absorbing composition is used. The near-infrared absorbing composition according to the present invention comprises components (A) to (E). Component (A): A copper complex in which a compound having a structure represented by general formula (I) is coordinated. Component (B): A compound having a structure represented by general formula (II). Component (C): A compound having a structure represented by general formula (III) or (IV). Component (D): A compound having a structure represented by general formula (V). Component (E): A solvent in which the value of the polar term δ_{P} of the Hansen solubility parameter is in the range of 3-6, and the value of the hydrogen bond term δ_{H} of the Hansen solubility parameter is in the range of 3-6.

### TECHNICAL FIELD

The present invention relates to a near-infrared light absorbing composition, a near-infrared light absorbing cured film, and an optical member.

### BACKGROUND ART

In recent years, solid state imaging devices for color images have been used in video cameras, digital still cameras, mobile phones with a camera function, and the like. The solid state imaging device is, for example, a charge coupled device (CCD) or a complementary metal oxide semiconductor (CMOS) image sensor. These solid state imaging devices use, in their light receiving sections, silicon photodiodes having sensitivity to light in the near-infrared wavelength region. Therefore, the solid state imaging device is required to perform visibility correction. For the visibility correction, a near-infrared light cut filter which is an optical filter is often used.

Such a near-infrared light cut filter is roughly classified into an absorption type and a reflection type. Conventionally, a reflection type has been used, and light reflection by a dielectric multilayer film has been used in order to shield infrared rays or ultraviolet rays.

However, a reflective layer applied to the reflective type has a characteristic of being susceptible to incident angle dependence. Therefore, recently, the full absorption type has been mainly studied. In recent years, an optical filter using a film containing a light absorber has been attracting attention.

The optical filter using the film containing the light absorber is also advantageous in terms of reducing the size and thickness of an imaging apparatus. When light enters such optical filter, transmittance characteristics of the optical filter are less likely to be influenced by an incident angle. Therefore, use of the optical filter allows a satisfactory image with little change in color tone to be obtained at the time of imaging even when the light is incident obliquely.

In recent years, as a material for producing such a near-infrared light cut filter, a near-infrared light absorbing composition using a copper phosphonate complex has been disclosed.

For example, Patent Literature 1 discloses a near-infrared light absorbing composition containing a near-infrared absorbent containing a phosphonic acid compound and copper ions, and a Ti compound. However, the composition disclosed in Patent Literature 1 has room for improvement in terms of storage stability and moist/heat resistance of a cured film.

Patent Literature 2 discloses an infrared light absorbing composition containing a light absorber and an alkoxysilane monomer. The light absorber is formed of a phosphonic acid having a phenyl group or a halogenated phenyl group and a copper ion. However, the composition disclosed in Patent Literature 2 has a problem in storage stability and moist/heat resistance of the cured film.

### CITATION LIST

### Patent Literature

Patent Document 1: International Publication No. 2019-221061
Patent Document 2: International Publication No. 2018-173386

### SUMMARY OF INVENTION

### Technical Problem

The present invention has been made in view of the above-mentioned situations. A problem to be solved by the present invention is to provide a near-infrared light absorbing composition capable of forming a cured film excellent in storage stability and excellent in moist/heat resistance, and a near-infrared light absorbing cured film and an optical member using the same.

### Solution to Problem

In order to solve the above problem, the present inventors have studied the cause of the above problem and the like. As a result, the present inventors have found that the above-described problems can be solved by incorporating a specific copper phosphonate complex, a specific phosphate ester, a specific Ti compound, a specific Si compound and a specific solvent, thereby completing the present invention.

That is, the above-described problems according to the present invention are solved by the following means.
1. A near-infrared light absorbing composition including the following components (A) to (E):
(A) component: A copper complex coordinated with a compound having a structure represented by the following General Formula (I).

### [Chemical Formula 1]

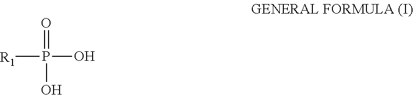

[In the General Formula (I), R₁ is an alkyl group having 1 to 20 carbon atoms and may further have a substituent group.]
(B) component: A compound having a structure represented by the following General Formula (II):

### [Chemical Formula 2]

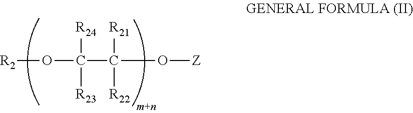

[In the General Formula (II), R₂ is an alkyl group having 1 to 20 carbon atoms or an aryl group having 6 to 20 carbon atoms, and may further have a substituent group. R₂₁ to R₂₄ each independently represents a hydrogen atom or an alkyl group having 1 to 4 carbon atoms. m represents an average addition number of a partial structural unit in which all of R₂₁ to R₂₄ are hydrogen atoms, and is in a range of 0 to 19. n represents an average addition number of a partial structural unit in which at least one of R₂₁ to R₂₄ is an alkyl group having 1 to 4 carbon atoms, and is in a range of 0 to 19. m+n represents a total number of m and n, and is in a range of 1 to 20. Z represents a structural unit selected from, the following formulas (Z-1) and (Z-2).]

### [Chemical Formula 3]

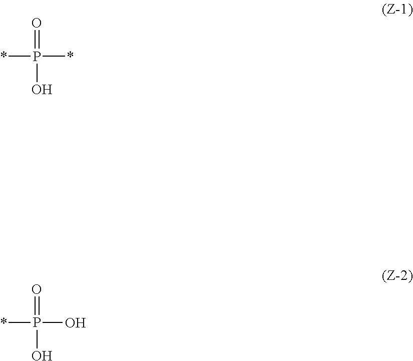 [SMILES: *P(*)(=O)O ; *P(=O)(O)O]

(C) component: A compound having a structure represented by the following General Formula (III) or (IV):

(R₃O)₄₋ₘTi(O—R₄—OH)ₘ General Formula (III)

(R₃O)₄₋ₘTi(OCOR₅)ₘ General Formula (IV)

[In the General Formulas (III) and (IV), m is an integer of 1 to 4. R₄ is an alkylene group having 1 to 30 carbon atoms, and may further have the substituent group. R₃ and R₅ are each the independent alkyl group having 1 to 30 carbon atoms, and may further have the substituent group.]
(D) component: A compound having a structure represented by the following General Formula (V):

R₆—(CH₂)ₘ—Si(CH₃)ₙ—(OR₇)₃₋ₙ General Formula (V)

[In the General Formula (V), R₆ represents a vinyl group, styryl group, acryloxy group, methacryloxy group, mercapto group, epoxy group, epoxycyclohexyl group or glycidoxy group, and may further have the substituent group. R₇ is an alkyl group having 1 to 3 carbon atoms. m is an integer of 0 to 8. n is 0 or 1.]
(E) component: A solvent having a value of a polarity parameter δ_{P} of a Hansen Solubility Parameter within a range of 3 to 6 and a value of a hydrogen bonding parameter δ_{H} within a range of 3 to 6.
2. The near-infrared light absorbing composition according to aspect 1, wherein the compound having a structure represented by the General Formula (II) simultaneously has at least one each of a partial structure satisfying the following condition (i) and a partial structure satisfying the following condition (ii), Condition (i): R₂₁ to R₂₄ are all hydrogen atoms.

Condition (ii): At least one of R₂₁ to R₂₄ is an alkyl group having 1 to 4 carbon atoms. and, wherein m and n in the General Formula (II) are each in a range of 1 to 19.
3. The near-infrared light absorbing composition according to aspect 1, wherein a content of the (C) component is in a range of 1 to 30% by mass with respect to the (A) component.
4. The near-infrared light absorbing composition according to aspect 1, wherein a content of the (D) component is in a range of 1 to 30% by mass with respect to the (A) component.
5. The near-infrared light absorbing composition according to aspect 1, wherein R₆ in the general formula (V) is an acryloxy group or a methacryloxy group.
6. The near-infrared light absorbing composition according to aspect 1, wherein the (E) component is cyclopentyl methyl ether or 4-methyltetrahydropyran.
7. A near-infrared light absorbing cured film including:
a cured product of the near-infrared light absorbing composition according to any one of aspects 1 to 6.
8. An optical member including:
a cured product of the near-infrared light absorbing composition according to any one of aspects 1 to 6.

### Advantageous Effects of Invention

The above-described means of the present invention can provide a near-infrared light absorbing composition that has excellent storage stability and can form a cured film having excellent moist/heat resistance, and a near-infrared light absorbing cured film and an optical member each using the same.

The expression mechanism or action mechanism of the effect of the present invention is not clear, but it is presumed as follows.

In the composition containing the copper phosphonate complex and the phosphate ester, the phosphate ester acts as a dispersant for the copper phosphonate complex. In a case where the Ti compound is simply added thereto, the storage stability of the near-infrared light absorbing composition is deteriorated. This is presumed to be due to the crosslinking action of the Ti compound.

The near-infrared light absorbing composition of the present invention further contains a Si compound and a specific solvent. Thus, the crosslinking action of the Ti compound is suppressed, and the storage stability of the near-infrared light absorbing composition is improved. In addition, when the solvent is removed at the time of forming the cured film, the suppressed crosslinking action of the Ti compound is exhibited. Furthermore, at this time, a synergistic effect of the crosslinking action of the Ti compound and the Si compound is also expressed. Due to these effects, the moist/heat resistance of the cured film is improved.

### BRIEF DESCRIPTION OF DRAWINGS

FIG. 1 This is a schematic cross-sectional view showing an example of a configuration of a near-infrared light cut filter.

FIG. 2 This is a schematic cross-sectional view illustrating an example of a configuration of a solid state imaging device image sensor.

FIG. 3 This is a schematic cross-sectional view showing an example of a configuration of a camera module.

### DESCRIPTION OF EMBODIMENTS

The near-infrared light absorbing composition of the present invention is characterized by containing the above-described (A) to (E) components. This feature is a technical feature common to or corresponding to the following embodiments.

According to an embodiment of the present invention, it is preferred that the compound having a structure represented by a General Formula (II) simultaneously has at least one partial structure satisfying the following condition (i) and at least one partial structure satisfying the following condition (ii), and each of m and n in the General Formula (II) is within a range of 1 to 19. Thus, an effect of the (B) component as a dispersant is enhanced.
Condition (i): R₂₁ to R₂₄ are all hydrogen atoms.
Condition (ii): At least one of R₂₁ to R₂₄ is an alkyl group having 1 to 4 carbon atoms.

According to an embodiment of the present invention, it is preferable that a content of the (C) component is in a range of 1 to 30% by mass with respect to the (A) component. Thus, the storage stability of the near-infrared light absorbing composition and moist/heat resistance of the near-infrared light absorbing cured film are improved in a well-balanced manner.

According to an embodiment of the present invention, it is preferable that a content of the (D) component is in a range of 1 to 30% by mass relative to the (A) component. Thus, the storage stability of the near-infrared light absorbing composition and moist/heat resistance of the near-infrared light absorbing cured film are improved in a well-balanced manner.

According to an embodiment of the present invention, it is preferred that R₆ in a General Formula (V) is an acryloxy group or a methacryloxy group. Thus, the storage stability of the near-infrared light absorbing composition and the moist/heat resistance of the cured film are further improved.

According to an embodiment of the present invention, the (E) component is preferably cyclopentyl methyl ether or 4-methyltetrahydropyran. These can disperse the near-infrared light absorbing composition in an appropriate state. Thus, the storage stability of the near-infrared light absorbing composition is further improved.

The near-infrared light absorbing cured film according to the present invention includes a cured product of the near-infrared light absorbing composition according to the present invention.

An optical member according to the present invention includes a cured product of the near-infrared light absorbing composition according to the present invention.

Hereinafter, the present invention, constituent elements thereof, and modes and aspects for carrying out the present invention will be described in detail. In the present application, “to” is used to mean that the numerical values described before and after the “to” are included as the lower limit value and the upper limit value.

### [Outline of Near-Infrared Light Absorbing Composition of Present Invention]

A near-infrared light absorbing composition according to the present invention includes the following (A) to (E) components.

### [(A) Component]

The (A) component is a copper complex to which a compound having a structure represented by the following General Formula (I) is coordinated. The compound having the structure represented by the following General Formula (I) is a phosphonate compound. Namely, the (A) component is a copper phosphonate complex. The (A) component is a near-infrared light absorbent.

### [Chemical Formula 4]

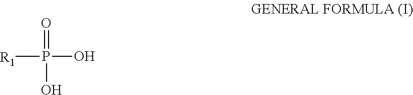

[In the General Formula (I), R₁ is an alkyl group having 1 to 20 carbon atoms and may further have a substituent group.]

Examples of the substituent group that R₁ may have include the following.
Alkyl group (for example, methyl group, ethyl group, trifluoromethyl group, isopropyl group, etc.), ⋅Alkoxy group (for example, methoxy group, ethoxy group, etc.)
Halogen atom (for example, fluorine atom, etc.)
Cyano group
Nitro group
Dialkylamino group (for example, dimethylamino group, etc.)
Trialkylsilyl group (for example, trimethylsilyl group, etc.)

R₁ is preferably the alkyl group having 1 to 20 carbon atoms in terms of excellent moist/heat resistance and near-infrared light absorption properties. R₁ is more preferably the alkyl group having 1 to 4 carbon atoms from the viewpoint that both near-infrared light absorptivity and visible transmittance can be achieved.

Examples of the phosphonic acid in which R₁ is an alkyl group having 1 to 20 carbon atoms include the following.
Methylphosphonic acid
Ethylphosphonic acid
Propylphosphonic acid
Butylphosphonic acid
Pentylphosphonic acid
Hexylphosphonic acid
Heptylphosphonic acid
Octylphosphonic acid
Nonylphosphonic acid
Decylphosphonic acid

The compound having a structure represented by the General Formula (I) in the (A) component is particularly preferably propylphosphonic acid and butylphosphonic acid.

The near-infrared light absorbing composition may contain, as the (A) component, a plurality of types of copper complexes to which phosphonic acids having different alkyl groups are coordinated.

As the compound having the structure represented by the General Formula (I), a commercially available product can be used.

It is sufficient that at least one compound having the structure represented by the General Formula (I) is coordinated in the copper complex to which the compound having the structure represented by the General Formula (I) is coordinated. The copper complex may be coordinated with a compound other than the compound having the structure represented by the General Formula (I).

The structure of the copper complex coordinated with the compound having the structure represented by the General Formula (I) is, for example, represented by the following General Formula (IC).

### [Chemical Formula 5]

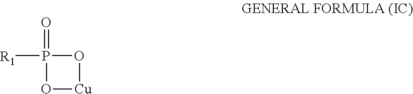

R₁ in the General Formula (IC) is the same as R₁ in the General Formula (I).

Of the hydroxy groups including the phosphonic acid, the hydroxy group directly bonded to a phosphorus atom is referred to as a “reactive hydroxy group”. In the General Formula (IC), two reactive hydroxy groups of one phosphonic acid react with the same copper ion to form the copper complex. However, the form of the copper phosphonate complex is not limited thereto.

The (A) component contained in the near-infrared light absorbing composition may be one type or two or more types.

Phosphonic acids can be synthesized with reference to known methods described in, for example, Japanese Unexamined Patent Publication No. 2016-94512, Japanese Unexamined Patent Publication No. 2016-124903.

In the near-infrared light absorbing composition, the copper phosphonate complex is mainly in the form of fine particles.

The content of the (A) component in the near-infrared light absorbing composition is preferably in a range of 3 to 40% by mass, and more preferably in a range of 10 to 30% by mass. When the content is 3% by mass or more, a thick cured film is easily formed. When the content is 10% by mass or more, the thick cured film is more easily formed. When the content is 40% by mass or less, aggregation of particles and an increase in viscosity of the composition can be suppressed, and the storage stability of the composition becomes satisfactory. When the content is 30% by mass or less, the storage stability of the composition becomes more satisfactory.

It is preferable that the copper complex fine particles are uniformly dispersed when the cured film is formed, from the viewpoint of spectral characteristics. For that purpose, it is preferable that the particle diameter of the copper complex fine particles in the near-infrared light absorbing composition (dispersion liquid) is small. The average particle diameter of the copper complex fine particle in the near-infrared light absorbing composition is preferably 200 nm or less, more preferably 100 nm or less, and still more preferably 80 nm or less. The average particle diameter can be measured by a dynamic light scattering method using an ELSZ-1000ZS manufactured by Otsuka Electronics Co., Ltd.

### [(B) Component]

The (B) component is a compound having a structure represented by the following General Formula (II), and is a phosphate ester compound. The (B) component exhibits an action of forming a nanosized small particle diameter when the copper phosphonate complex is formed. The (B) component contributes to maintaining dispersibility of the copper phosphonate complex particles in a medium.

### [Chemical Formula 6]

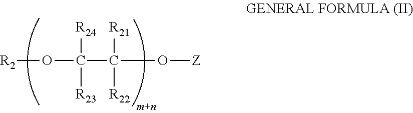

[In the General Formula (II), R₂ is the alkyl group having 1 to 20 carbon atoms or the aryl group having 6 to 20 carbon atoms, and may further have the substituent group. R₂₁ to R₂₄ each independently represent a hydrogen atom or the alkyl group having 1 to 4 carbon atoms. m represents an average addition number of a partial structural unit in which all of R₂₁ to R₂₄ are hydrogen atoms, and is in a range of 0 to 19. n represents an average addition number of a partial structural unit in which at least one of R₂₁ to R₂₄ is an alkyl group having 1 to 4 carbon atoms, and is in a range of 0 to 19. m+n represents the total number of m and n, and is in a range of 1 to 20. Z represents a structural unit selected from, the following formulas (Z-1) and (Z-2).]

### [Chemical Formula 7]

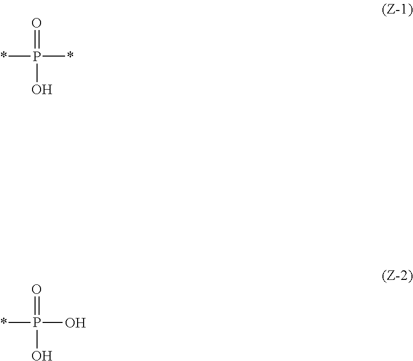 [SMILES: *P(*)(=O)O ; *P(=O)(O)O]

A partial structure in parentheses in the formula when all of R₂₁ to R₂₄ are hydrogen atoms is referred to as an “ethylene oxide structure”. In the formula, m is the average addition number of the ethylene oxide structure.

A partial structure in parentheses in the formula in which at least one of R₂₁ to R₂₄ is an alkyl group having 1 to 4 carbon atoms and the others are hydrogen atoms is referred to as an “alkyl-substituted ethylene oxide structure”. In the formula, n is the average addition number of the alkyl-substituted ethylene oxide structure.

In the compound having a structure represented by General Formula (II), either m or n is 1 or more. Thus, the compound has a high capability of forming a complex with copper and is highly effective as a dispersant.

It is preferable that the compound having a structure represented by General Formula (II) simultaneously has at least one each of a partial structure satisfying the following condition (i) and a partial structure satisfying the following condition (ii). Thus, an effect of the (B) component as a dispersant is enhanced.
Condition (i): R₂₁ to R₂₄ are all hydrogen atoms.
Condition (ii): At least one of R₂₁ to R₂₄ is an alkyl group having 1 to 4 carbon atoms.

It is preferable that m and n in the General Formula (II) each fall within a range of 1 to 19. The compound has many kinds of isomers depending on the combination of the ethylene oxide structure and the alkyl-substituted ethylene oxide structure. Thus, entropy increases, so that the compound has a high effect as the dispersant. In the above compound, the influence of steric hindrance of the substituent group (R₂₁ to R₂₄) is suppressed, and the copper complex can form a finely dispersed state. Therefore, the respective effects of the ethylene oxide structure and the alkyl-substituted ethylene oxide structure are exhibited in a well-balanced manner. Therefore, the compound can further improve the dispersibility and the dispersion stability of the near-infrared light absorbing composition.

In the General Formula (II), it is more preferable that at least one of R₂₁ to R₂₄ is a methyl group, from the viewpoint of dispersibility of the copper complex.

In the General Formula (II), it is preferable that R₂ is an alkyl group having 6 to 16 carbon atoms, from the viewpoint of dispersibility of the copper complex and resistance to moist and heat.

The compound having a structure represented by the General Formula (II) is a diester when Z is the formula (Z-1) and is a monoester when Z is the formula (Z-2).

A mixing ratio of the diester and the monoester is preferably such that a molar ratio of the monoester to a total amount of the diester and the monoester is within a range of 20 to 95%.

Specific examples of the compound having the structure represented by the General Formula (II) are shown in the following Tables I to V The compound having the structure represented by the General Formula (II) according to the present invention is not limited thereto.

There are Exemplary Compounds in which both (Z-1) and (Z-2) are described in the column of “structure” of “Z” in Tables I to V Such Exemplary Compounds are a mixture of a compound in which Z is formula (Z-1) and a compound in which Z is formula (Z-2).

TABLE 1
TABLE I

| | | ETHYLENE | | ALKYL-SUBSTITUTED | | | | | Z | | |
|---|---|---|---|---|---|---|---|---|---|---|---|
| | R₂ | OXIDE | | ETHYLENE OXIDE | | | | | | | MONOESTER |
| | SUBSTITUENT | STRUCTURE | | STRUCTURE | | | | | STRUCTURE | | MOLAR |
| No. | GROUP | m | R₂₁-R₂₄ | n | R₂₁ | R₂₂ | R₂₃ | R₂₄ | DIESTER | MONOESTER | RATIO [%] |
| II-1 | METHYL | 5 | H | 5 | H | H | METHYL | H | Z-1 | Z-2 | 50 |
| II-2 | METHYL | 19 | H | 5 | H | H | METHYL | H | Z-1 | Z-2 | 50 |
| II-3 | METHYL | 5 | H | 5 | H | H | ETHYL | H | Z-1 | Z-2 | 50 |
| II-4 | METHYL | 5 | H | 5 | H | H | METHYL | H | Z-1 | Z-2 | 70 |
| II-5 | METHYL | 5 | H | 5 | H | H | BUTYL | H | Z-1 | Z-2 | 50 |
| II-6 | ETHYL | 5 | H | 4 | H | H | METHYL | H | Z-1 | Z-2 | 50 |
| II-7 | ETHYL | 19 | H | 3 | H | H | METHYL | H | Z-1 | Z-2 | 50 |
| II-8 | ETHYL | 9 | H | 9 | H | H | H | METHYL | Z-1 | Z-2 | 30 |
| II-9 | ETHYL | 8 | H | 8 | H | H | METHYL | H | Z-1 | Z-2 | 50 |
| II-10 | n-PROPYL | 3 | H | 3 | H | H | METHYL | H | Z-1 | Z-2 | 50 |
| II-11 | n-PROPYL | 15 | H | 15 | H | H | METHYL | H | Z-1 | Z-2 | 50 |
| II-12 | n-PROPYL | 1.5 | H | 3 | H | H | METHYL | H | Z-1 | Z-2 | 50 |
| II-13 | n-PROPYL | 3 | H | 3 | H | H | METHYL | H | Z-1 | Z-2 | 70 |
| II-14 | n-PROPYL | 3 | H | 3 | METHYL | H | METHYL | H | Z-1 | Z-2 | 50 |
| II-15 | ISOPROPYL | 10 | H | 10 | H | H | ETHYL | H | Z-1 | Z-2 | 50 |
| II-16 | ISOPROPYL | 2 | H | 1.5 | METHYL | H | METHYL | H | Z-1 | Z-2 | 20 |
| II-17 | ISOPROPYL | 5 | H | 5 | H | H | METHYL | H | Z-1 | Z-2 | 80 |
| II-18 | n-BUTYL | 2 | H | 2 | H | H | METHYL | H | Z-1 | Z-2 | 50 |
| II-19 | n-BUTYL | 1 | H | 1 | H | H | ETHYL | H | Z-1 | Z-2 | 30 |
| II-20 | n-BUTYL | 1.5 | H | 1.5 | H | METHYL | H | H | Z-1 | Z-2 | 50 |

TABLE 2
TABLE II

| | | ETHYLENE | | ALKYL-SUBSTITUTED | | | | | Z | | |
|---|---|---|---|---|---|---|---|---|---|---|---|
| | R₂ | OXIDE | | ETHYLENE OXIDE | | | | | | | MONOESTER |
| | SUBSTITUENT | STRUCTURE | | STRUCTURE | | | | | STRUCTURE | | MOLAR |
| No. | GROUP | m | R₂₁-R₂₄ | n | R₂₁ | R₂₂ | R₂₃ | R₂₄ | DIESTER | MONOESTER | RATIO [%] |
| II-21 | n-BUTYL | 2 | H | 4 | H | H | METHYL | H | Z-1 | Z-2 | 50 |
| II-22 | ISOBUTYL | 3 | H | 3 | ETHYL | H | H | H | Z-1 | Z-2 | 50 |
| II-23 | ISOBUTYL | 3 | H | 3 | H | H | METHYL | H | Z-1 | Z-2 | 60 |
| II-24 | ISOBUTYL | 5 | H | 5 | H | H | METHYL | H | Z-1 | Z-2 | 50 |
| II-25 | tert-BUTYL | 3 | H | 5 | H | H | METHYL | H | Z-1 | Z-2 | 50 |
| II-26 | tert-BUTYL | 10 | H | 5 | H | H | METHYL | H | Z-1 | Z-2 | 30 |
| II-27 | tert-BUTYL | 3 | H | 3 | H | H | METHYL | H | Z-1 | Z-2 | 50 |
| II-28 | n-PENTYL | 3 | H | 3 | H | H | METHYL | H | Z-1 | Z-2 | 50 |
| II-29 | n-PENTYL | 1 | H | 2 | H | H | METHYL | H | Z-1 | Z-2 | 50 |
| II-30 | n-PENTYL | 4 | H | 4 | H | H | METHYL | H | Z-1 | Z-2 | 60 |
| II-31 | ISOPENTYL | 4 | H | 4 | H | H | METHYL | H | Z-1 | Z-2 | 40 |
| II-32 | ISOPENTYL | 8 | H | 8 | H | H | METHYL | H | Z-1 | Z-2 | 50 |
| II-33 | ISOPENTYL | 2 | H | 2 | H | H | METHYL | H | Z-1 | Z-2 | 50 |
| II-34 | n-HEXYL | 2.5 | H | 2.5 | H | H | METHYL | H | Z-1 | Z-2 | 50 |
| II-35 | n-HEXYL | 3 | H | 3 | H | H | METHYL | H | Z-1 | Z-2 | 60 |
| II-36 | n-HEXYL | 3 | H | 1.5 | H | H | METHYL | H | Z-1 | Z-2 | 50 |
| II-37 | n-HEXYL | 5 | H | 5 | METHYL | H | METHYL | H | Z-1 | Z-2 | 98 |
| II-38 | n-HEXYL | 3 | H | 1 | H | H | METHYL | H | Z-1 | Z-2 | 70 |
| II-39 | n-HEXYL | 1 | H | 1 | H | H | METHYL | H | Z-1 | Z-2 | 60 |
| II-40 | n-HEXYL | 1 | H | 3 | H | H | METHYL | H | Z-1 | Z-2 | 50 |

TABLE 3
TABLE III

| | | ETHYLENE | | ALKYL-SUBSTITUTED | | | | | Z | | |
|---|---|---|---|---|---|---|---|---|---|---|---|
| | R₂ | OXIDE | | ETHYLENE OXIDE | | | | | | | MONOESTER |
| | SUBSTITUENT | STRUCTURE | | STRUCTURE | | | | | STRUCTURE | | MOLAR |
| No. | GROUP | m | R₂₁-R₂₄ | n | R₂₁ | R₂₂ | R₂₃ | R₂₄ | DIESTER | MONOESTER | RATIO [%] |
| II-41 | ISOHEXYL | 3 | H | 3 | H | H | METHYL | H | Z-1 | Z-2 | 50 |
| II-42 | ISOHEXYL | 5 | H | 5 | H | H | METHYL | H | Z-1 | Z-2 | 50 |
| II-43 | ISOHEXYL | 2 | H | 2 | H | H | METHYL | H | Z-1 | Z-2 | 50 |
| II-44 | n-OCTYL | 3 | H | 3 | H | H | METHYL | H | Z-1 | Z-2 | 40 |
| II-45 | n-OCTYL | 2 | H | 2 | H | H | METHYL | H | Z-1 | Z-2 | 50 |
| II-46 | n-OCTYL | 1 | H | 2 | H | H | METHYL | H | Z-1 | Z-2 | 50 |
| II-47 | n-OCTYL | 5 | H | 5 | H | H | METHYL | H | Z-1 | Z-2 | 50 |
| II-48 | n-QCTYL | 2 | H | 1 | H | H | METHYL | H | Z-1 | Z-2 | 60 |
| II-49 | n-OCTYL | 1.5 | H | 1.5 | H | H | METHYL | H | Z-1 | Z-2 | 50 |
| II-50 | 2-ETHYLHEXYL | 3 | H | 3 | H | H | METHYL | H | Z-1 | Z-2 | 50 |
| II-51 | 2-ETHYLHEXYL | 2 | H | 2 | H | H | METHYL | H | Z-1 | Z-2 | 40 |
| II-52 | 2-ETHYLHEXYL | 2.5 | H | 2.5 | H | H | METHYL | H | Z-1 | Z-2 | 50 |
| II-53 | 2-ETHYLHEXYL | 1.5 | H | 1.5 | H | H | METHYL | H | Z-1 | Z-2 | 50 |
| II-54 | 2-ETHYLHEXYL | 5 | H | 7 | METHYL | H | H | H | Z-1 | Z-2 | 30 |
| II-55 | ISOOCTYL | 2.5 | H | 2.5 | H | H | METHYL | H | Z-1 | Z-2 | 40 |
| II-56 | ISOOCTYL | 5 | H | 5 | METHYL | H | METHYL | H | Z-1 | Z-2 | 18 |
| II-57 | ISOOCTYL | 1.2 | H | 1.8 | H | H | METHYL | H | Z-1 | Z-2 | 50 |
| II-58 | ISOOCTYL | 2 | H | 3 | H | H | METHYL | H | Z-1 | Z-2 | 50 |
| II-59 | n-DECYL | 1.5 | H | 1.5 | METHYL | H | METHYL | H | Z-1 | Z-2 | 50 |
| II-60 | n-DECYL | 3 | H | 3 | H | H | METHYL | H | Z-1 | Z-2 | 50 |

TABLE 4
TABLE IV

| | | ETHYLENE | | ALKYL-SUBSTITUTED | | | | | Z | | |
|---|---|---|---|---|---|---|---|---|---|---|---|
| | R₂ | OXIDE | | ETHYLENE OXIDE | | | | | | | MONOESTER |
| | SUBSTITUENT | STRUCTURE | | STRUCTURE | | | | | STRUCTURE | | MOLAR |
| No. | GROUP | m | R₂₁-R₂₄ | n | R₂₁ | R₂₂ | R₂₃ | R₂₄ | DIESTER | MONOESTER | RATIO [%] |
| II-61 | n-DECYL | 1.5 | H | 1.5 | H | H | ETHYL | H | Z-1 | Z-2 | 50 |
| II-62 | n-DECYL | 2 | H | 5 | METHYL | METHYL | H | H | Z-1 | Z-2 | 95 |
| II-63 | ISODECYL | 5 | H | 5 | H | H | METHYL | H | Z-1 | Z-2 | 50 |
| II-64 | ISODECYL | 3 | H | 3 | H | H | METHYL | H | Z-1 | Z-2 | 50 |
| II-65 | ISODECYL | 2 | H | 2 | H | H | METHYL | H | Z-1 | Z-2 | 50 |
| II-66 | n-DODECYL | 1.5 | H | 1.5 | H | H | METHYL | H | Z-1 | Z-2 | 50 |
| II-67 | n-DODECYL | 2 | H | 2 | H | H | METHYL | H | Z-1 | Z-2 | 60 |
| II-68 | n-DODECYL | 3 | H | 3 | H | H | METHYL | H | Z-1 | Z-2 | 50 |
| II-69 | n-DODECYL | 1.3 | H | 1.7 | H | H | METHYL | H | Z-1 | Z-2 | 60 |
| II-70 | n-DODECYL | 2 | H | 2 | H | H | METHYL | H | Z-1 | Z-2 | 50 |
| II-71 | n-DODECYL | 3 | H | 3 | H | H | METHYL | H | Z-1 | Z-2 | 50 |
| II-72 | n-DODECYL | 2 | H | 2 | H | H | METHYL | H | Z-1 | Z-2 | 60 |
| II-73 | 2-BUTYLOCTYL | 5 | H | 3 | H | H | METHYL | H | Z-1 | Z-2 | 50 |
| II-74 | 2-BUTYLOCTYL | 1.5 | H | 1.5 | H | H | METHYL | H | Z-1 | Z-2 | 50 |
| II-75 | 2-BUTYLOCTYL | 1.5 | H | 1.5 | H | METHYL | H | H | Z-1 | Z-2 | 60 |
| II-76 | 2-BUTYLOCTYL | 1 | H | 3 | H | H | METHYL | H | Z-1 | Z-2 | 50 |
| II-77 | 2-HEXYLOCTYL | 1 | H | 1.5 | H | H | METHYL | H | Z-1 | Z-2 | 30 |
| II-78 | 2-HEXYLOCTYL | 2 | H | 3 | H | H | METHYL | H | Z-1 | Z-2 | 50 |
| II-79 | n-PENTADECYL | 1.5 | H | 1.5 | H | H | METHYL | H | Z-1 | Z-2 | 50 |
| II-80 | n-PENTADECYL | 3 | H | 2 | H | H | METHYL | H | Z-1 | Z-2 | 50 |

TABLE 5
TABLE V

| | | ETHYLENE | | ALKYL-SUBSTITUTED | | | | | Z | | |
|---|---|---|---|---|---|---|---|---|---|---|---|
| | R₂ | OXIDE | | ETHYLENE OXIDE | | | | | | | MONOESTER |
| | SUBSTITUENT | STRUCTURE | | STRUCTURE | | | | | STRUCTURE | | MOLAR |
| No. | GROUP | m | R₂₁-R₂₄ | n | R₂₁ | R₂₂ | R₂₃ | R₂₄ | DIESTER | MONOESTER | RATIO [%] |
| II-81 | n-STEARYL | 3 | H | 3 | H | H | METHYL | H | Z-1 | Z-2 | 70 |
| II-82 | n-STEARYL | 1.5 | H | 2.5 | H | H | METHYL | H | Z-1 | Z-2 | 50 |
| II-83 | n-STEARYL | 3 | H | 3 | H | H | METHYL | H | Z-1 | Z-2 | 50 |
| II-84 | OCTADECYL | 1.5 | H | 1.5 | H | H | METHYL | H | Z-1 | Z-2 | 50 |
| II-85 | PHENYL | 5 | H | 5 | H | H | METHYL | H | Z-1 | Z-2 | 50 |
| II-86 | PHENYL | 3 | H | 3 | H | H | METHYL | H | Z-1 | Z-2 | 50 |
| II-87 | PHENYL | 1 | H | 1 | H | H | METHYL | H | Z-1 | Z-2 | 50 |
| II-88 | XYLYL | 3 | H | 4 | H | H | METHYL | H | Z-1 | Z-2 | 50 |
| II-89 | n-OCTYL | 3 | H | 0 | — | — | — | — | Z-1 | Z-2 | 50 |
| II-90 | n-DODECYL | 0 | — | 3 | H | H | METHYL | H | Z-1 | Z-2 | 50 |
| II-91 | n-DODECYL | 3 | H | 0 | — | — | — | — | Z-1 | Z-2 | 50 |

Exemplary Compound II-1 will be specifically described. The Exemplary Compound II-1 is the mixture of the compound (diester) in which Z is the formula (Z-1) and the compound (monoester) in which Z is the formula (Z-2).

The compound (monoester) in which Z is the formula (Z-2) is represented by, for example, the structure of the following exemplary compound II-1-1. The compound (diester) in which Z is the formula (Z-1) is represented by, for example, the structure of the following exemplary compound II-1-2.

### [Chemical Formula 8]

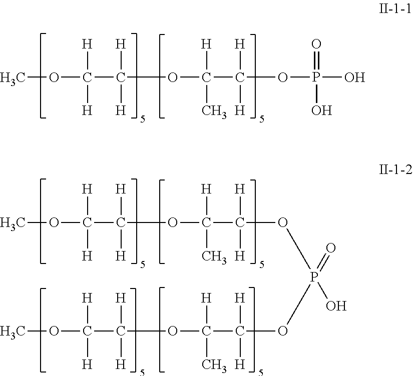

In the Exemplary Compound II-1, the molar ratio of the compound (monoester) in which Z is the formula (Z-2) is 50%. That is, the Exemplary Compound II-1 contains the same molar amounts of the Exemplary Compound II-1-1 and the Exemplary Compound II-1-2.

Each of m and n is the average addition number. Therefore, even in Exemplary Compound 1 in which m is 5 and n is 5, the number of ethylene oxide structures in one molecule is not necessarily five, and the number of alkyl-substituted ethylene oxide structures is not necessarily five.

In the General Formula (II), the order of the ethylene oxide structure and the alkyl-substituted ethylene oxide structure is not particularly limited. The compound in which the respective structures are randomly arranged is also included in the compound having the structure represented by the General Formula (II). The order of the ethylene oxide structure and the alkyl-substituted ethylene oxide structure can be arbitrarily changed depending on the synthesis method.

The compound having a structure represented by the General Formula (II) can be synthesized, for example, with reference to the methods described in the following documents.
Japanese Unexamined Patent Publication No. 2005-255608
Japanese Unexamined Patent Publication No. 2015-000396
Japanese Unexamined Patent Publication No. 2015-000970
Japanese Unexamined Patent Publication No. 2015-178072
Japanese Unexamined Patent Publication No. 2015-178073
Japanese Patent No. 4422866
International Publication No. 2019-221061

The (B) component contained in the near-infrared light absorbing composition may be one type or two or more types.

The content of the (B) component is preferably in a range of 40 to 80% by mass, and more preferably in a range of 50 to 70% by mass with respect to the (A) component. Thus, the dispersibility of the near-infrared light absorbing composition, the storage stability of the near-infrared light absorbing composition, and the moist/heat resistance of the cured film can be more satisfactorily achieved at the same time.

When the ratio of the (B) component is small, the ratio to the (A) component, which is effective in absorbing near-infrared rays, becomes large, and the near-infrared absorptivity becomes good. Further, it has been found that the phosphate ester compound as the (B) component causes white turbidity in a high-temperature and high-humidity environment. Therefore, by reducing the ratio of the (B) component, the moist/heat resistance of the cured film is improved. Provided that a certain amount of the phosphate ester compound is required for maintaining the dispersibility of the copper complex fine particles.

### [(C) Component]

The (C) component is a compound having a structure represented by the following General Formula (III) or (IV), and is a Ti compound.

(R₃O)₄₋ₘTi(O—R₄—OH)ₘ General Formula (III)

(R₃O)₄₋ₘTi(OCOR₅)ₘ General Formula (IV)

In the General Formulas (III) and (IV), m is an integer of 1 to 4. R₄ is an alkylene group having 1 to 30 carbon atoms, and may further have the substituent group. R₃ and R₅ are each the independent alkyl group having 1 to 30 carbon atoms, and may further have the substituent group.

The alkyl group having 1 to 30 carbon atoms represented by R₃ and R₅ may be linear or branched.

Examples of the alkyl group having 1 to 30 carbon atoms include the following.
Methyl group
Ethyl group
n-propyl group
Isopropyl group
n-butyl group
tert-butyl group
n-hexyl group
2-ethylhexyl group
n-octyl group
2-butyloctyl group
2-hexyloctyl group
n-decyl group
2-hexyldecyl group
n-dodecyl group
n-stearyl group
Isostearyl group

R₃ and R₅ are preferably the alkyl group having 6 to 20 carbon atoms.

The alkylene group having 1 to 30 carbon atoms represented by R₄ may be straight-chain or branched.

Examples of the alkylene group having 1 to 30 carbon atoms include the following.
Methylene group
Ethylene group
n-propylene group
Isopropylene group
n-butylene group
tert-butylene group
n-hexylene group
2-ethylhexylene group
n-octylene group
2-butyloctylene group
2-hexyloctylene group
n-decylene group
2-hexyldecylene group
n-dodecylene group
n-stearylene group
Isostearylene group

Preferably, R₄ is the alkylene group having 6 to 20 carbon atoms.

Examples of the substituent group that R₃ and R₅ may each have include the following.
Alkyl group (for example, methyl group, ethyl group, trifluoromethyl group, isopropyl group, etc.)
Alkoxy group (for example, methoxy group, ethoxy group, etc.)
Halogen atom (for example, fluorine atom, etc.)
Cyano group
Nitro group
Dialkylamino group (for example, dimethylamino group, etc.)
Trialkylsilyl group (for example, trimethylsilyl group, etc.)
Triarylsilyl group (for example, triphenylsilyl group, etc.)
Triheteroarylsilyl group (for example, tripyridylsilyl group, etc.)
Benzyl group
Aryl group (for example, phenyl group, etc.)
Heteroaryl group (for example, pyridyl group, carbazolyl group, etc.)
Fused ring group (for example, 9,9′-dimethylfluorene, carbazole, dibenzofuran, etc.)

The compound having a structure represented by the General Formula (III) is more preferably a compound forming a chelate structure. Examples of the compound include the following titanium chelate compounds.
Titanium ethylene diolate
Titanium propylene diolate
Titanium butylene diolate
Titanium pentylene diolate
Titanium hexylene diolate
Titanium 2-ethyl 1,3-hexylene diolate
Titanium octylene diolate

Specific example of the compound having the structure represented by the General Formula (III) are set forth below. The compound having the structure represented by the General Formula (III) according to the present invention is not limited thereto.

### [Chemical Formula 9]

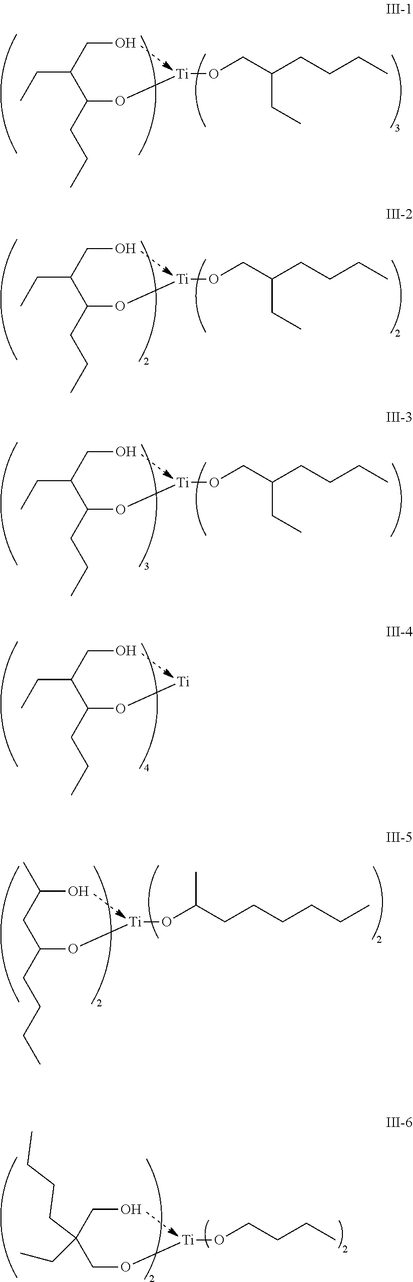

### [Chemical Formula 10]

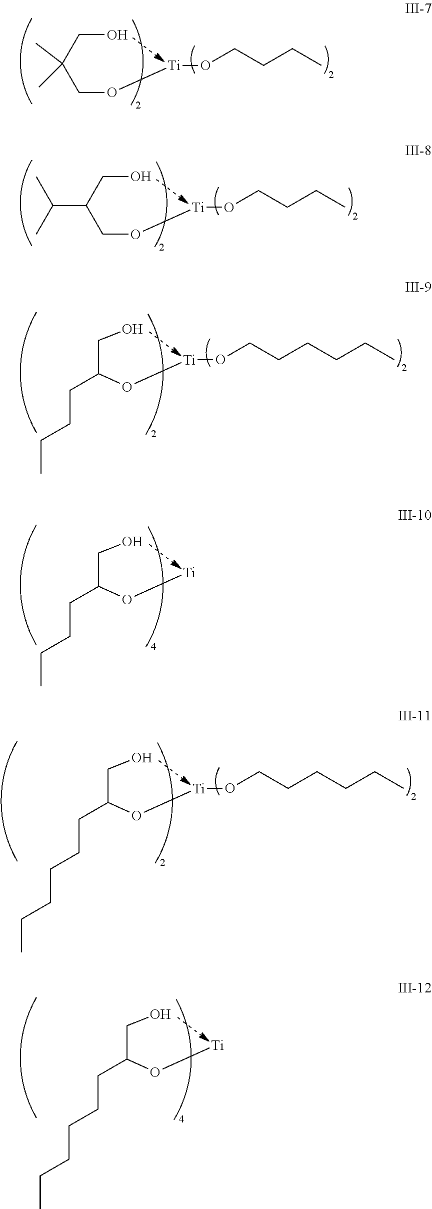

The compound having the structure represented by the General Formula (III) is also available as a commercial product. Examples of the commercial product include “ORGATICS TC245” (manufactured by Matsumoto Fine Chemical Co., Ltd).

The compound having the structure represented by the General Formula (IV) is more preferably the compound forming an acylate structure. Examples of the compound include the following titanium acylate compounds.
Titanium caprylate
Titanium caprate
Titanium laurate
Titanium myristate
Titanium palmitate
Titanium stearate
Titanium isostearate

Specific examples of the compound having the structure represented by the General Formula (IV) are set forth below. The compound having the structure represented by General Formula (IV) according to the present invention is not limited thereto.

### [Chemical Formula 11]

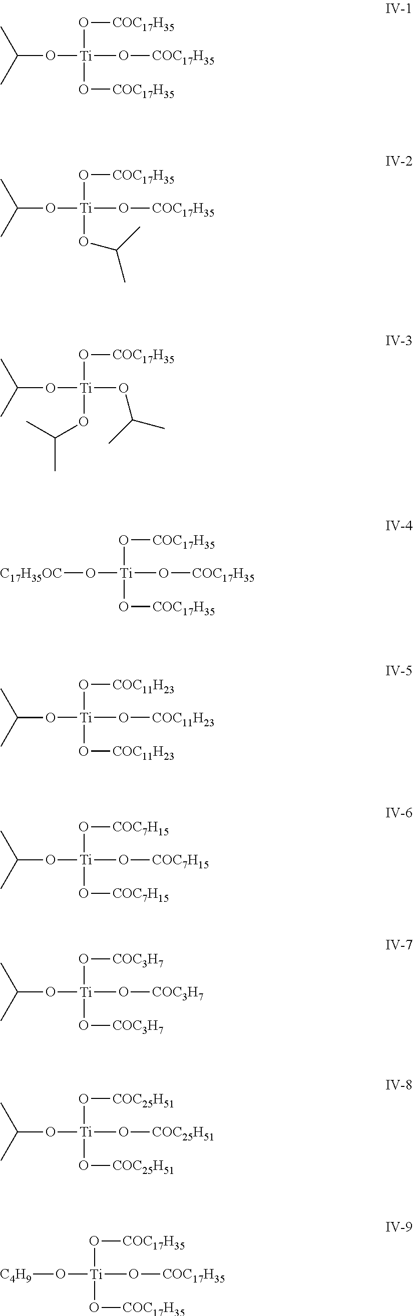

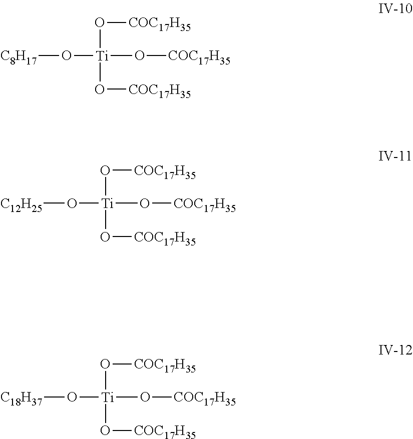

The compound having the structure represented by the General Formula (IV) is also available as the commercial product. Examples of the commercial product include “ORGATICS TC-800” (manufactured by Matsumoto Fine Chemical Co., Ltd).

The compound having the structure represented by the General Formula (III) or the General Formula (IV) can be obtained with reference to, for example, a synthesis method described in Japanese Unexamined Patent Publication No. 2011-219704.

The (C) component contained in the near-infrared light absorbing composition may be one type or two or more types.

The content of the (C) component is preferably in a range of 1 to 30% by mass, and more preferably in a range of 3 to 20% by mass with respect to the (A) component. Thus, the storage stability of the near-infrared light absorbing composition and moist/heat resistance of the near-infrared light absorbing cured film are improved in a well-balanced manner. When the content of the (C) component is a certain amount or more, the moist/heat resistance of the cured film is likely to be satisfactory. When the content of the (C) component is the certain amount or less, the storage stability of the near-infrared light absorbing composition tends to be satisfactory.

### [(D) Component]

The (D) component is the compound having the structure represented by the following General Formula (V), and is a Si compound. The compound having the structure represented by the General Formula (V) suppresses a crosslinking action of the Ti compound in the near-infrared light absorbing composition and improves the storage stability of the near-infrared light absorbing composition. In addition, a synergistic effect of the crosslinking action of the Ti compound and the Si compound is exhibited at the time of forming the cured film. Therefore, in a case where the Ti compound and the Si compound are used in combination, the moist/heat resistance of the cured film is more improved than in a case where the Ti compound is used alone.

R₆—(CH₂)ₘ—Si(CH₃)ₙ—(OR₇)₃₋ₙ General Formula (V)

[In the General Formula (V), R₆ represents a vinyl group, styryl group, acryloxy group, methacryloxy group, mercapto group, epoxy group, epoxycyclohexyl group or glycidoxy group, and may further have the substituent group. R₇ is an alkyl group having 1 to 3 carbon atoms. m is an integer of 0 to 8. n is 0 or 1.]

R₆ is preferably the acryloxy group or the methacryloxy group. Thus, the storage stability of the near-infrared light absorbing composition and the moist/heat resistance of the cured film are further improved.

Specific examples of the compound having the structure represented by the General Formula (V) are set forth below. The compound having the structure represented by the General Formula (V) according to the present invention is not limited thereto.

### [Chemical Formula 12]

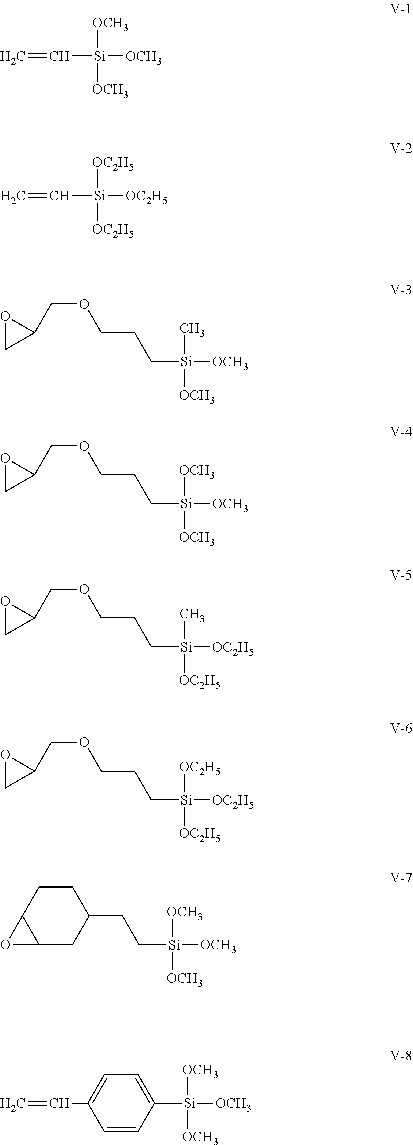

### [Chemical Formula 13]

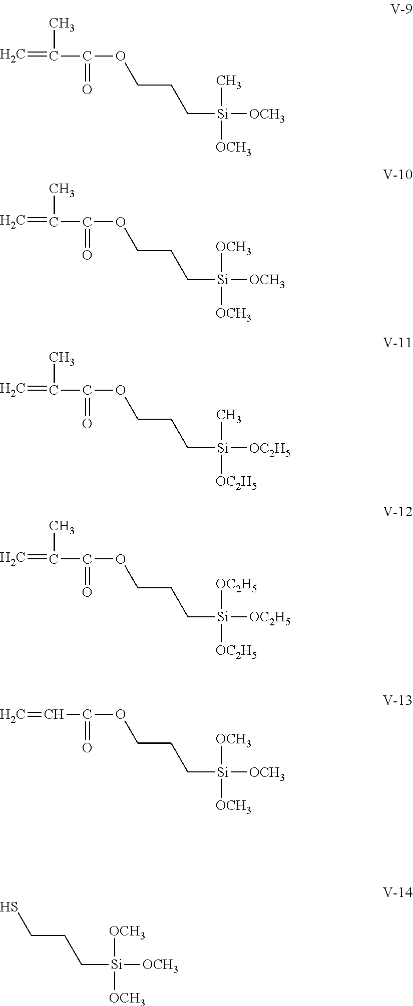 [SMILES: C=C(C)C(=O)OCCC[Si](C)(OC)OC ; C=C(C)C(=O)OCCC[Si](OC)(OC)OC ; C=C(C)C(=O)OCCC[Si](C)(OCC)OCC ; C=C(C)C(=O)OCCC[Si](OCC)(OCC)OCC ; C=CC(=O)OCCC[Si](OC)(OC)OC ; CO[Si](CCCS)(OC)OC]

The compound having the structure represented by the General Formula (V) is also available as the commercial product. Examples of the commercial product include the following.
KBM-1003
KBE-1003
KBM-1083
KBM-303
KBM-402
KBM-403
KBE-402
KBE-403
KBM-4803
KBM-1403
KBM-502
KBM-503
KBE-502
KBE-503
KBM-5803
KBM-5103
KBM-802
KBM 803 (all of the above manufactured by Shin-Etsu Chemical Co., Ltd)

The (D) component contained in the near-infrared light absorbing composition may be one type or two or more types.

The compound having the structure represented by the General Formula (V) can be obtained with reference to, for example, a synthesis method described in Japanese Unexamined Patent Publication No. H 9-157280.

The content of the (D) component is preferably in a range of 1 to 30% by mass, and more preferably in a range of 3 to 20% by mass with respect to the (A) component. Thus, the storage stability of the near-infrared light absorbing composition and moist/heat resistance of the near-infrared light absorbing cured film are improved in a well-balanced manner. When the content of the (D) component is the certain amount or less, the moist/heat resistance of the cured film is likely to be satisfactory. When the content of the (D) component is the certain amount or more, the storage stability of the near-infrared light absorbing composition is likely to be satisfactory.

### [(E) Component]

The (E) component is a solvent having a value of a polarity parameter δ_{P} of a Hansen Solubility Parameter within a range of 3 to 6 and a value of a hydrogen bonding parameter δ_{H} within a range of 3 to 6.

Hansen Solubility Parameters (HSP) are values serving as an index of solubility of a substance. The HSP is obtained by dividing the solubility parameter introduced by Hildebrand into three components of a dispersion parameter δ_{D}, the polarity parameter δ_{P}, and the hydrogen bonding parameter δ_{H}, and expressing the components in a three dimensional space.

The dispersion parameter δ_{D} represents energy derived from dispersion forces. The polar parameter δ_{P} represents the energy derived from polar forces. The hydrogen bonding term δ_{H} represents the energy derived from hydrogen bonding forces.

In the present invention, the unit of δ_{D}, δ_{P} and δ_{H} is MPa^{1/2}

The definition and calculation method of HSP are described in the following documents. “Charles M. Hansen, Hansen Solubility Parameters: A Users Handbook (CRC Press, 2007)”

The compounds having similar HSP vectors can be determined to have high solubility. The similarity between vectors can be determined by an HSP distance.

The HSP can be an indicator of not only solubility but also the degree to which a certain substance is likely to be present in another substance, that is, dispersibility.

The HSP of various solvents used in the present invention is a value obtained by the following commercially available computer software. “Hansen Solubility Parameters in Practice (HSPiP)”

The (E) component is not particularly limited except for requirements of the HSP described above, and is preferably an ether-based solvent.

It is preferable that the solvent which is the (E) component has a cycloalkyl group or a cycloether group, from the viewpoint of dispersibility.

The cycloalkyl group is more preferably a cyclopentyl group or a cyclohexyl group from the viewpoint of dispersibility. The cycloether group is more preferably a tetrahydrofuran group or a tetrahydropyran group from the viewpoint of dispersibility.

The term “dispersibility” refers to a performance or a function as a dispersion medium for dispersing components constituting the near-infrared light absorbing composition in an appropriate state in the near-infrared light absorbing composition.

The term “storage stability” refers to a performance or function of maintaining the dispersion state of various components constituting the near-infrared light absorbing composition in an appropriate state without change or with little change over time, due to a change in environmental conditions, or the like.

The (E) component is more preferably cyclopentyl methyl ether or 4-methyltetrahydropyran, and particularly preferably cyclopentyl methyl ether. These can disperse the near-infrared light absorbing composition in an appropriate state. Thus, the storage stability of the near-infrared light absorbing composition is further improved.

Specific examples and a comparative example of the solvent as the (E) component are shown in Table VI. The solvent according to the present invention is not limited thereto.

TABLE VI

| | | | | | BOILING |
|---|---|---|---|---|---|
| | COMPOUND NAME | δ_{D} | δ_{P} | δ_{H} | POINT [°C] |
| (E) COMPONENT | CYCLOPENTYL METHYL ETHER | 16.30 | 3.47 | 3.89 | 106 |
| EXAMPLE | 4-METHYLTETRAHYDROPYRAN | 16.49 | 4.40 | 4.99 | 105 |
| | TETRAHYDROFURAN | 16.71 | 4.88 | 5.79 | 66 |
| | DIETHYL ETHER | 14.67 | 4.85 | 4.42 | 34.6 |
| | 2-METHYLTETRAHYDROFURAN | 16.35 | 4.84 | 4.85 | 80.2 |
| | DIBUTYL ETHER | 15.49 | 3.14 | 3.02 | 141 |
| COMPARATIVE | TOLUENE | 18.02 | 2.58 | 3.30 | 111 |
| EXAMPLE | | | | | |

It is preferable that a boiling point of the solvent which is the (E) component is in a range of 80 to 150 °C from the viewpoint of preventing cracks at the time of forming the cured film.

The (E) component contained in the near-infrared light absorbing composition may be one type or two or more types.

It is more preferable that the content of the (E) component is in a range of 50 to 95% by mass with respect to the total amount of the near-infrared light absorbing composition from the viewpoints of dispersibility and storage stability.

Other solvents can be used in combination as long as the effect of the present invention is not inhibited. Preferred examples of the other solvents include aliphatic hydrocarbon solvents and ether solvents.

### [Near-Infrared Absorbing Cured Film]

The near-infrared light absorbing cured film of the present invention contains a cured product of the near-infrared light absorbing composition.

The near-infrared light absorbing cured film of the present invention is suitable as a constituent of, for example, the following for a CCD, a CMOS, or other light receiving elements.
Visibility correction member
Photometric member
Heat ray absorbing member
Composite optical filter
Lens member (eyeglasses, sunglasses, goggles, optical system, optical waveguide system)
Fiber member (optical fiber)
Noise cutting member
Display cover or display filter for plasma display front plate, etc.
Projector front plate
Light source heat ray cutting member
Color tone correction member
Illumination luminance adjustment member
Optical element (optical amplification element, wavelength conversion element, etc.)
Faraday element
Optical communication functional device such as isolator, etc.
Element for optical disc

The near-infrared light absorbing cured film can be produced, for example, by the following sequence. First, a resin material is dissolved in the near-infrared light absorbing composition (dispersion liquid) of the present invention to prepare an application liquid for forming a near-infrared light absorbing cured film. The application liquid is coated on a substrate by a wet coating method. The coating film is cured by performing a predetermined heating treatment or the like.

Examples of the wet coating method include the following methods.
Dripping method (drop cast)
Dispenser method
Spin coater method
Slit spin coater method
Slit coater method
Screen printing method
Applicator method

The thickness of the near-infrared light absorbing cured film is preferably in a range of 10 to 500 μm, and more preferably in a range of 10 to 300 μm.

It is preferable that the resin material has optical transparency with respect to visible light and near-infrared light, and is capable of dispersing fine particles of the near-infrared light absorbing composition.

The (A) component which is a copper phosphonate complex is a substance having a relatively low polarity and is well dispersed in a hydrophobic material. Therefore, the resin material for forming the near-infrared light absorbing film is preferably the resin material having a polysiloxane structure or the resin material having the acryl group, the epoxy group, or the phenyl group. Among these, a resin having a polysiloxane structure is particularly preferable because it is less likely to be thermally decomposed, has high light transmittance with respect to visible light and near-infrared light, and has high heat resistance.

Examples of the resin material having a polysiloxane structure include the following.
KR-255
KR-300
KR-2621-1
KR-211
KR-311
KR-216
KR-212
KR 251 (manufactured by Shin-Etsu Chemical Co., Ltd)

Examples of the resin material having the epoxy group include the following.
KJC-X5 (manufactured by Shin-Etsu Chemical Co., Ltd).
EpiFine Series (manufactured by KISCO)

As the resin material having an acrylic group, a (meth) acrylic acid ester monomer is preferable. Examples of the (meth) acrylic acid ester monomer include the following.
Alkyl (meth) acrylates such as methyl (meth) acrylate, ethyl (meth) acrylate, n-propyl (meth) acrylate, and n-butyl (meth) acrylate
Modified (meth) acrylates such as phenoxy (meth) acrylate
Polyfunctional (meth) acrylates such as trimethylolpropane tri (meth) acrylate and pentaerythritol tetra (meth) acrylate

As the resin material for forming the near-infrared light absorbing film, a polymer (resin polymer) may be used. Examples of the polymer (resin polymer) include the following.
Polymer of (meth) acrylic acid ester compound
Polymers of aromatic vinyl compounds such as styrene, α-methylstyrene, methoxystyrene, and divinylbenzene
Cycloolefin polymer (COP)

As used herein, the term “(meth) acrylic group” refers to both a “methacrylic group” and an “acrylic group”.

The application liquid for forming a near-infrared light absorbing cured film may contain other additives within a range not impairing the object and effect of the present invention. Examples of the other additives include a sensitizer, a crosslinking agent, a curing accelerator, a polymerization initiator, a filler, a thermal curing accelerator, a thermal polymerization inhibitor, and a plasticizer. The application liquid may further contain other components such as auxiliary agents. Examples of the auxiliary agents include conductive particles, a filler, a defoaming agent, a flame retardant, a leveling agent, a peeling accelerator, an antioxidant, a fragrance, a surface tension modifier, a chain transfer agent, and a surface treating agent. By appropriately including these components in the application liquid, properties such as stability and film physical properties of the near-infrared light absorbing cured film can be adjusted.

### [Spectral Characteristics of Near-Infrared Light Absorbing Composition (Dispersion Liquid)]

The average spectral transmittance of the near-infrared light absorbing composition in a wavelength region of wavelengths 450 to 600 nm is preferably equal to or greater than 70%, more preferably equal to or greater than 80%, and still more preferably equal to or greater than 90%. These are values measured by diluting the near-infrared light absorbing composition with solvents so that the maximum spectral transmittance in wavelengths of 850 to 1000 nm becomes 10%. Thus, the cured film has satisfactory visible light transmittance.

As a measurement apparatus for spectral transmittance, for example, a spectrophotometer V-570 manufactured by JASCO Corporation can be used.

### [Spectral Characteristics of Near-Infrared Light Absorbing Cured Film]

It is preferable that the average spectral transmittance of the near-infrared light absorbing cured film in a wavelength region of wavelengths from 450 to 600 nm is 80% or more in terms of visible light transmittance.

It is preferable that the average spectral transmittance of the near-infrared light absorbing cured film in a wavelength region of wavelengths 850 to 1000 nm is 10% or less in terms of near-infrared light absorbing properties.

It is preferable that the average spectral transmittance of the near-infrared light absorbing cured film in a wavelength region of wavelengths 850 to 1080 nm is 1% or less in terms of near-infrared light absorbing properties.

The wavelength at which the spectral transmittance decreases with increasing wavelength at wavelengths of 600 to 700 nm and the spectral transmittance is 50% at wavelengths of 600 to 800 nm is defined as the cutoff wavelength. It is preferable that the cutoff wavelength of the near-infrared light absorbing cured film for light incident on the surface thereof at an incident angle of 0° is in the range of 600 to 750 nm. This improves the near-infrared light absorptivity of the cured film.

### [Optical Member]

The optical member of the present invention contains the cured product of the near-infrared light absorbing composition.

The near-infrared light absorbing cured film of the present invention can be used as various optical members or components.

Hereinafter, an example in which the near-infrared light absorbing composition or the near-infrared light absorbing cured film is applied as the optical member or the component will be described.

### (Near-Infrared Light Cut Filter)

The optical member of the present invention is, for example, a near-infrared light cut filter. The near-infrared light cut filter includes, for example, a near-infrared light absorbing layer on at least one surface of a transparent dielectric substrate. The near-infrared light absorbing layer is the cured product of the near-infrared light absorbing composition of the present invention.

It is preferable to further provide the dielectric multilayer film on at least one surface of the transparent dielectric substrate, from the viewpoint that the spectral characteristics of the near-infrared light cut filter can be more freely adjusted.

The near-infrared light absorbing layer and the dielectric multilayer film may be provided in contact with the transparent dielectric substrate, or may be provided with another intermediate layer interposed therebetween.

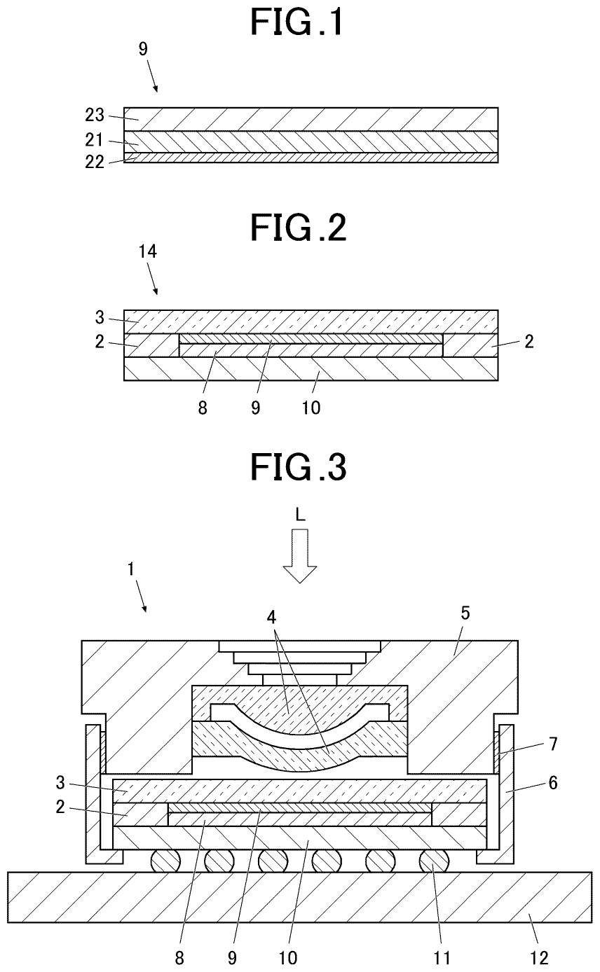

FIG. 1 is a schematic cross-sectional view showing a configuration example of a near-infrared light cut filter.

The near-infrared light cut filter 9 illustrated in FIG. 1 includes a near-infrared light absorbing layer 22 on one surface of a transparent dielectric substrate 21. The near-infrared light cut filter 9 further includes a dielectric multilayer film 23 on the other surface of the transparent dielectric substrate 21.

The material of the transparent dielectric substrate is not particularly limited as long as the object of the present invention can be achieved. The transparent dielectric substrate may be made of, for example, glass or an optical resin. Examples of the optical resin include polycarbonate (PC), polymethyl methacrylate (PMMA), cycloolefin polymer (COP), and silicone.

The transparent dielectric substrate is preferably 0.01 to 1 mm thick.

Since the transparent dielectric substrate needs to transmit visible light, it preferably has an average spectral transmittance of 80% or more in the range of wavelengths of 450 to 600 nm.

The near-infrared light absorbing cured film of the present invention can be applied to the near-infrared light absorbing layer.

The near-infrared light cut filter can be produced by forming the near-infrared light absorbing cured film directly on the transparent dielectric substrate as the near-infrared light absorbing layer.

The dielectric multilayer film is a film formed by stacking a plurality of layers made of materials having different refractive indexes, and is used for controlling the transmittance of each wavelength of light. By providing the dielectric multilayer film in combination with the near-infrared light absorbing layer, it is possible to more freely adjust the spectral characteristics of the near-infrared light cut filter.

The spectral characteristics of the dielectric multilayer film can be adjusted by the thickness of each layer and the type of material. As the material of each layer of the dielectric multilayer film, for example, the following dielectrics may be used.
Titanium oxide
Silicon oxide
Aluminum oxide
Zirconium oxide
Tantalum pentoxide
Niobium pentoxide
Lanthanum oxide
Yttrium oxide
Zinc oxide
Zinc sulfide
Indium oxide
Silica
Alumina
Lanthanum fluoride
Magnesium fluoride
Sodium aluminum hexafluoride

The near-infrared light cut filter including the dielectric multilayer film can be manufactured by stacking each dielectric layer on the transparent dielectric substrate. Examples of the lamination method include a vacuum deposition method, a chemical vapor deposition method, and a sputtering method.

The near-infrared light cut filter including the dielectric multilayer film can also be produced by bonding a separately produced dielectric multilayer film to a transparent dielectric substrate with an adhesive.

### (Image Sensor For Solid State Imaging Device)

The near-infrared light cut filter can be included in the image sensor for the solid state imaging device. The image sensor for the solid state imaging device is a member mainly composed of a solid state imaging device substrate including the light receiving element. The image sensor for the solid state imaging device may include a planarization layer, a glass substrate, and the like in addition to the near-infrared light cut filter.

The image sensor for the solid state imaging device may include the planarization layer, the glass substrate, and the like in addition to the near-infrared light cut filter.

FIG. 2 is a schematic cross-sectional view illustrating an example of the configuration of the image sensor for the solid state imaging device.

The solid state imaging device image sensor 14 illustrated in FIG. 2 includes a solid state imaging device substrate 10 including a light receiving element on a surface of a light receiving side of a silicone substrate, a planarization layer 8 provided on the solid state imaging device substrate 10, a near-infrared light cut filter 9 provided on the planarization layer 8, and a glass substrate 3 (light transmitting substrate) disposed on the near-infrared light cut filter 9. Each member is bonded by an adhesive 2.

### (Camera Module)

The image sensor for the solid state imaging device may be included in a camera module. The camera module may include, in addition to the image sensor for the solid state imaging device, an imaging lens, a lens holder, a light shielding and electromagnetic shield, and the like.

FIG. 3 is a schematic cross-sectional view illustrating an example of a configuration of the camera module.

The camera module 1 illustrated in FIG. 3 includes the image sensor for the solid state imaging device as in FIG. 2, a lens holder 5, an imaging lens 4, and a light shielding and electromagnetic shield 6. Similarly to FIG. 2, the image sensor for the solid state imaging device includes the solid state imaging device substrate 10, the planarization layer 8, the near-infrared light cut filter 9, and the glass substrate 3. The light shielding and electromagnetic shield 6 is arranged so as to surround the periphery of the image sensor for the solid state imaging device. The respective members are bonded by the adhesive 7.

Furthermore, the camera module 1 is connected to a circuit board 12 which is a mounting board, via a solder member 11 (connection material) which are connection members.

In the camera module 1, incident light L from the outside sequentially passes through the image lens 4, the glass substrate 3, the near-infrared light cut filter 9, and the planarization layer 8. Thereafter, the incident light L reaches the light receiving element of the solid-state imaging element substrate 10.

### EXAMPLE

Hereinafter, the present invention will be specifically described with reference to Examples, but the present invention is not limited thereto. In the following Examples, operations were performed at room temperature (25 °C) unless otherwise specified. In the following Examples, unless otherwise specified, “%” and “parts” mean “% by mass” and “parts by mass”, respectively.

### <Preparation of Near-Infrared Light Absorbing Composition>

According to the following method, the near-infrared light absorbing composition No. 1 was prepared.

The following compounds and the solvent in the following amounts were mixed and stirred for 3 hours, and the liquid was filtered to remove insoluble matter to prepare a solution A.
copper (II) acetate mono-hydrate 18 g
tetrahydrofuran 800 g

A solution was prepared by dissolving a compound having a structure represented by the following General Formula (II) in the following amount in the following solvent. The solution A was added thereto and stirred at room temperature for 30 minutes to prepare a solution B.
Exemplary Compound II-66 10 g
tetrahydrofuran 70 g

The compound having the structure represented by the following General Formula (I) was dissolved in the following solvents in the following amounts to prepare a solution C.
butylphosphonic acid 12 g
tetrahydrofuran 70 g

While the solution B was stirred, the solution C was added thereto, and then the mixture was stirred at room temperature for 16 hours. The resulting solution is referred to as a solution D.

The total amount of the solution D and 300 g of methylcyclohexane were placed in a flask. While this was heated to 50 to 100 °C, desolvation and deacetic acid treatment were performed by a rotary evaporator. To this was then added cyclopentyl methyl ether 300 g. An operation of removing the solvent with the rotary evaporator was repeated three times. Thus, the solvent was replaced by cyclopentyl methyl ether, and the concentration of the (A) component was adjusted to 10% by mass. The resulting solution is referred to as a solution E.

The compound having the structure represented by the following General Formula (III) and the compound having the structure represented by the following General Formula (V) were dissolved in the following solvents in the following amounts. This was added to 100 g of the solution E, and stirred at room temperature for 30 minutes, to obtain the near-infrared light absorbing composition No. 1.
Exemplary Compound III-2 1.0 g
Exemplary Compound V-10 1.0 g
cyclopentyl methyl ether 10 g

The near-infrared light absorbing compositions No. 2 to 36 were prepared in the same manner as in the preparation of the near-infrared light absorbing composition No. 1, except for the following changes as in Table VII and Table VIII.
Compound species having a structure represented by General Formula (I)
Compound species having a structure represented by General Formula (II)
Compound species having a structure represented by General Formula (III) or (IV) and amount added
Compound species having a structure represented by General Formula (V) and amount added
Solvent species

### <Evaluation of Dispersibility>

The dispersibility of the near-infrared light absorbing composition was evaluated by measuring the average particle diameter of the particles in the near-infrared light absorbing composition. The near-infrared light absorbing composition was diluted with toluene so that the solid content concentration became 0.5% by mass. The average particle diameter was measured by a dynamic light scattering method using ELSZ-1000ZS manufactured by Otsuka Electronics Co., Ltd. The evaluation was performed according to the following evaluation criterion, which was used as a measure of dispersibility. The evaluation results are listed in the following table.
A: The average particle diameter is less than or equal to 100 nm.
B: The average particle diameter is more than 100 nm 150 nm or less.
C: The average particle diameter is more than 150 nm and 200 nm or less.
D: The average particle diameter is more than 200 nm.

### <Evaluation of Storage Stability>

The storage stability of the near-infrared light absorbing composition was evaluated by measuring a change in a particle diameter and a change in viscosity of the near-infrared light absorbing composition over time.

### (Change In Particle Diameter)

The near-infrared light absorbing composition was left to stand at room temperature for 7 days. Thereafter, the average particle diameter of the particles in the near-infrared light absorbing composition was measured by the same method as described above. An average particle diameter variation rate [%] was determined from the average particle diameters before and after the standing. The average particle diameter variation rate [%] was evaluated according to the following standard. The evaluation results are listed in the following table.
A: The average particle diameter variation rate is less than 10%.
B: The average particle diameter variation rate is 10% or more and less than 30%.
C: The average particle diameter variation rate is 30% or more and less than 50%.
D: The average particle diameter variation rate is 50% or more.
   (Change In Viscosity) The viscosity of the near-infrared light absorbing composition was measured. Thereafter, the near-infrared light absorbing composition was heated at 45 °C for 2 days. After the heating, the viscosity of the near-infrared light absorbing composition was measured again. A viscosity variation rate [%] was obtained from the viscosities before and after the heating. The viscosity variation rate [%] was evaluated according to the following standard. The evaluation results are listed in the following table.
A: The viscosity variation rate is less than 10%.
B: The viscosity variation rate is 10% or more and less than 30%.
C: The viscosity variation rate is 30% or more and less than 50%.
D: The viscosity variation rate is 50% or more.

TABLE 7
TABLE VII

| | | | (C) COMPONENT | | (D) COMPONENT | |
|---|---|---|---|---|---|---|
| NEAR-INFRARED | | | | CONTENT RATIO | | CONTENT RATIO |
| LIGHT | (A) | (B) | | RELATIVE | | RELATIVE |
| ABSORBING | COMPONENT | COMPONENT | | TO (A) | | TO (A) |
| COMPOSITION | COMPOUND | COMPOUND | COMPOUND | COMPONENT | COMPOUND | COMPONENT |
| No. | SPECIES | SPECIES | SPECIES | [% BY MASS] | SPECIES | [% BY MASS] |
| 1 | BUTYLPHOSPHONIC ACID | II-66 | III-2 | 10 | V-10 | 10 |
| 2 | BUTYLPHOSPHONIC ACID | II-66 | III-2 | 0.5 | V-10 | 10 |
| 3 | BUTYLPHOSPHONIC ACID | II-66 | III-2 | 1 | V-10 | 10 |
| 4 | BUTYLPHOSPHONIC ACID | II-66 | III-2 | 10 | V-10 | 0.5 |
| 5 | BUTYLPHOSPHONIC ACID | II-66 | III-2 | 10 | V-10 | 1 |
| 6 | BUTYLPHOSPHONIC ACID | II-66 | IV-1 | 10 | V-10 | 10 |
| 7 | BUTYLPHOSPHONIC ACID | II-66 | IV-1 | 0.5 | V-10 | 10 |
| 8 | BUTYLPHOSPHONIC ACID | II-66 | IV-1 | 1 | V-10 | 10 |
| 9 | BUTYLPHOSPHONIC ACID | II-66 | IV-1 | 10 | V-10 | 0.5 |
| 10 | BUTYLPHOSPHONIC ACID | II-66 | IV-1 | 10 | V-10 | 1 |
| 11 | BUTYLPHOSPHONIC ACID | II-66 | IV-1 | 20 | V-10 | 10 |
| 12 | BUTYLPHOSPHONIC ACID | II-66 | IV-1 | 30 | V-10 | 10 |
| 13 | BUTYLPHOSPHONIC ACID | II-66 | IV-1 | 35 | V-10 | 10 |
| 14 | BUTYLPHOSPHONIC ACID | II-66 | IV-1 | 10 | V-10 | 20 |
| 15 | BUTYLPHOSPHONIC ACID | II-66 | IV-1 | 10 | V-10 | 30 |
| 16 | BUTYLPHOSPHONIC ACID | II-66 | IV-1 | 10 | V-10 | 35 |
| 17 | BUTYLPHOSPHONIC ACID | II-66 | IV-1 | 10 | V-13 | 10 |
| 18 | BUTYLPHOSPHONIC ACID | II-66 | IV-1 | 0.5 | V-13 | 10 |
| 19 | BUTYLPHOSPHONIC ACID | II-66 | IV-1 | 1 | V-13 | 10 |
| 20 | BUTYLPHOSPHONIC ACID | II-66 | IV-1 | 10 | V-13 | 0.5 |
| 21 | BUTYLPHOSPHONIC ACID | II-66 | IV-1 | 10 | V-13 | 1 |
| 22 | BUTYLPHOSPHONIC ACID | II-66 | IV-1 | 10 | V-10 | 10 |
| 23 | BUTYLPHOSPHONIC ACID | II-66 | IV-1 | 10 | V-13 | 10 |
| 24 | BUTYLPHOSPHONIC ACID | II-91 | III-2 | 10 | V-10 | 10 |
| 25 | BUTYLPHOSPHONIC ACID | II-91 | IV-1 | 10 | V-10 | 10 |
| 26 | BUTYLPHOSPHONIC ACID | II-91 | IV-1 | 10 | V-13 | 10 |
| 27 | BUTYLPHOSPHONIC ACID | II-91 | IV-1 | 10 | V-10 | 10 |
| 28 | PROPYLPHOSPHONIC ACID | II-66 | III-2 | 10 | V-10 | 10 |
| 29 | PROPYLPHOSPHONIC ACID | II-66 | IV-1 | 10 | V-10 | 10 |
| 30 | PROPYLPHOSPHONIC ACID | II-66 | IV-1 | 10 | V-13 | 10 |
| 31 | PROPYLPHOSPHONIC ACID | II-91 | III-2 | 10 | V-10 | 10 |
| 32 | PROPYLPHOSPHONIC ACID | II-91 | IV-1 | 10 | V-10 | 10 |
| 33 | PROPYLPHOSPHONIC ACID | II-66 | IV-1 | 10 | V-10 | 10 |
| 34 | BUTYLPHOSPHONIC ACID | II-66 | — | — | V-10 | 10 |
| 35 | BUTYLPHOSPHONIC ACID | II-66 | III-2 | 10 | — | — |
| 36 | BUTYLPHOSPHONIC ACID | II-66 | III-2 | 10 | V-10 | 10 |

TABLE 8
TABLE VIII

| NEAR-INFRARED | | EVALUATION RESULTS | | | |
|---|---|---|---|---|---|
| LIGHT | | | STORAGE STABILITY | | |
| ABSORBING | | | PARTICLE | | |
| COMPOSITION | (E) COMPONENT | DISPERS- | DIAMETER | VISCOSITY | |
| No. | SOLVENT SPECIES | IBILITY | CHANGE | CHANGE | REMARKS |
| 1 | CYCLOPENTYL METHYL ETHER | A | A | A | PRESENT INVENTION |
| 2 | CYCLOPENTYL METHYL ETHER | A | A | B | PRESENT INVENTION |
| 3 | CYCLOPENTYL METHYL ETHER | A | A | A | PRESENT INVENTION |
| 4 | CYCLOPENTYL METHYL ETHER | A | A | B | PRESENT INVENTION |
| 5 | CYCLOPENTYL METHYL ETHER | A | A | A | PRESENT INVENTION |
| 6 | CYCLOPENTYL METHYL ETHER | A | A | A | PRESENT INVENTION |
| 7 | CYCLOPENTYL METHYL ETHER | A | A | B | PRESENT INVENTION |
| 8 | CYCLOPENTYL METHYL ETHER | A | A | A | PRESENT INVENTION |
| 9 | CYCLOPENTYL METHYL ETHER | A | A | B | PRESENT INVENTION |
| 10 | CYCLOPENTYL METHYL ETHER | A | A | A | PRESENT INVENTION |
| 11 | CYCLOPENTYL METHYL ETHER | A | A | A | PRESENT INVENTION |
| 12 | CYCLOPENTYL METHYL ETHER | A | A | A | PRESENT INVENTION |
| 13 | CYCLOPENTYL METHYL ETHER | A | A | B | PRESENT INVENTION |
| 14 | CYCLOPENTYL METHYL ETHER | A | A | A | PRESENT INVENTION |
| 15 | CYCLOPENTYL METHYL ETHER | A | A | A | PRESENT INVENTION |
| 16 | CYCLOPENTYL METHYL ETHER | A | A | B | PRESENT INVENTION |
| 17 | CYCLOPENTYL METHYL ETHER | A | A | A | PRESENT INVENTION |
| 18 | CYCLOPENTYL METHYL ETHER | A | A | B | PRESENT INVENTION |
| 19 | CYCLOPENTYL METHYL ETHER | A | A | A | PRESENT INVENTION |
| 20 | CYCLOPENTYL METHYL ETHER | A | A | B | PRESENT INVENTION |
| 21 | CYCLOPENTYL METHYL ETHER | A | A | A | PRESENT INVENTION |
| 22 | 4-METHYLTETRAHYDROPYRAN | A | A | A | PRESENT INVENTION |
| 23 | 4-METHYLTETRAHYDROPYRAN | A | A | A | PRESENT INVENTION |
| 24 | CYCLOPENTYL METHYL ETHER | A | A | A | PRESENT INVENTION |
| 25 | CYCLOPENTYL METHYL ETHER | A | A | A | PRESENT INVENTION |
| 26 | CYCLOPENTYL METHYL ETHER | A | A | A | PRESENT INVENTION |
| 27 | 4-METHYLTETRAHYDROPYRAN | A | A | A | PRESENT INVENTION |
| 28 | CYCLOPENTYL METHYL ETHER | A | A | A | PRESENT INVENTION |
| 29 | CYCLOPENTYL METHYL ETHER | A | A | A | PRESENT INVENTION |
| 30 | CYCLOPENTYL METHYL ETHER | A | A | A | PRESENT INVENTION |
| 31 | CYCLOPENTYL METHYL ETHER | A | A | A | PRESENT INVENTION |
| 32 | CYCLOPENTYL METHYL ETHER | A | A | A | PRESENT INVENTION |
| 33 | 4-METHYLTETRAHYDROPYRAN | A | A | A | PRESENT INVENTION |
| 34 | CYCLOPENTYL METHYL ETHER | B | C | C | COMPARATIVE EXAMPLE |
| 35 | CYCLOPENTYL METHYL ETHER | B | D | D | COMPARATIVE EXAMPLE |
| 36 | TOLUENE | B | C | C | COMPARATIVE EXAMPLE |

From the results shown in Table VIII, it is understood that the near-infrared light absorbing composition of the present invention is excellent in dispersibility and storage stability.

### <Production Of Near-Infrared Light Absorbing Cured Film>

The near-infrared light absorbing composition and the following resin material were mixed in a combination shown in Tables IX and X so that the solid content ratio of the resin material was 70% by mass. Thus, application liquids for forming the near-infrared light absorbing cured film No. 1 to 60 were prepared.

Details of the resin materials used are as follows.

(Resin material No. 1)
solution obtained by mixing 80% by mass of 2-ethylhexyl methacrylate, 19% by mass of trimethylolpropane triacrylate, and 1.0% by mass of a polymerization initiator Perbutyl ND (manufactured by NOF Corporation) (Resin material No2)
silicone resin KR311 (manufactured by Shin-Etsu Chemical Co., Ltd)

### (Resin Material No. 3)

solution prepared by dissolving DIANAL BR-87 (manufactured by Mitsubishi Chemical Corporation) in cyclopentyl methyl ether at 20% by mass

The application liquid for forming the near-infrared light absorbing cured film was cast-coated on the glass substrate. At this time, the coating amount was adjusted so that the maximum spectral transmittance in the range of wavelengths of 850 to 1000 nm after hardening was 10%. The glass substrate coated with the application liquid was pre-baked on a hot plate at 110 °C for 2 minutes.

Furthermore, the composition was cured by heat treatment the a hot plate. At this time, when the resin material 1 was used, the heating temperature was 120 °C and the heating time was 1 hour. When the resin material 2 was used, the heating temperature was 180 °C and the heating time was 1 hour. When the resin material 3 was used, the heating temperature was 120 °C and the heating time was 15 minutes.

Thus, the near-infrared light absorbing cured film No. 1 to 60 were made.

### <Evaluation of Moist/Heat Resistance of Near-Infrared Light Absorbing Cured Film>

Average transmittance Tₐᵥₑ₁ in the range of the wavelength region of 700 to 1200 nm of the near-infrared light absorbing cured film immediately after production was determined. Next, the near-infrared light absorbing cured film was allowed to stand under an environment of 85 °C and 85% RH for 1000 hours. The average transmittance Tₐᵥₑ₂ in the range of the wavelength region of 700 to 1200 nm of the near-infrared light absorbing cured film after standing was determined.

The extent of decrease in the visible light transmittance in Tₐᵥₑ₂ relative to Tₐᵥₑ₁ (Tₐᵥₑ₁-Tₐᵥₑ₂) was calculated. The extent of decrease in the visible light transmittance was evaluated according to the following standard and used as a measure of the moist/heat resistance. The evaluation results are listed in the following table.
A: The extent of decrease in the average transmittance is less than 3%.
B: The extent of decrease in the average transmittance is 3% or more and less than 5%.
C: The extent of decrease in the average transmittance is 5% or more and less than 10%.
D: The extent of decrease in the average transmittance is 10% or more.

TABLE 9
TABLE IX

| NEAR-INFRARED | APPLICATION LIQUID | | CURED | |
|---|---|---|---|---|
| LIGHT ABSORBING | NEAR-INFRARED | RESIN | FILM | |
| CURED FILM | LIGHT ABSORBING | MATERIAL | MOIST/HEAT | |
| No. | COMPOSITION No. | No. | RESISTANCE | REMARKS |
| 1 | 1 | 1 | A | PRESENT INVENTION |
| 2 | 1 | 2 | A | PRESENT INVENTION |
| 3 | 1 | 3 | A | PRESENT INVENTION |
| 4 | 2 | 1 | B | PRESENT INVENTION |
| 5 | 2 | 2 | B | PRESENT INVENTION |
| 6 | 2 | 3 | B | PRESENT INVENTION |
| 7 | 3 | 1 | A | PRESENT INVENTION |
| 8 | 3 | 2 | A | PRESENT INVENTION |
| 9 | 3 | 3 | A | PRESENT INVENTION |
| 10 | 4 | 1 | B | PRESENT INVENTION |
| 11 | 4 | 2 | B | PRESENT INVENTION |
| 12 | 4 | 3 | B | PRESENT INVENTION |
| 13 | 5 | 1 | A | PRESENT INVENTION |
| 14 | 5 | 2 | A | PRESENT INVENTION |
| 15 | 5 | 3 | A | PRESENT INVENTION |
| 16 | 6 | 1 | A | PRESENT INVENTION |
| 17 | 6 | 2 | A | PRESENT INVENTION |
| 18 | 6 | 3 | A | PRESENT INVENTION |
| 19 | 7 | 1 | B | PRESENT INVENTION |
| 20 | 7 | 2 | B | PRESENT INVENTION |
| 21 | 7 | 3 | B | PRESENT INVENTION |
| 22 | 8 | 1 | A | PRESENT INVENTION |
| 23 | 8 | 2 | A | PRESENT INVENTION |
| 24 | 8 | 3 | A | PRESENT INVENTION |
| 25 | 9 | 1 | B | PRESENT INVENTION |
| 26 | 9 | 2 | B | PRESENT INVENTION |
| 27 | 9 | 3 | B | PRESENT INVENTION |
| 28 | 10 | 1 | A | PRESENT INVENTION |
| 29 | 10 | 2 | A | PRESENT INVENTION |
| 30 | 10 | 3 | A | PRESENT INVENTION |

TABLE 10
TABLE X

| NEAR-INFRARED | APPLICATION LIQUID | | CURED | |
|---|---|---|---|---|
| LIGHT ABSORBING | NEAR-INFRARED | RESIN | FILM | |
| CURED FILM | LIGHT ABSORBING | MATERIAL | MOIST/HEAT | |
| No. | COMPOSITION No. | No. | RESISTANCE | REMARKS |
| 31 | 12 | 1 | A | PRESENT INVENTION |
| 32 | 12 | 2 | A | PRESENT INVENTION |
| 33 | 12 | 3 | A | PRESENT INVENTION |
| 34 | 13 | 1 | B | PRESENT INVENTION |
| 35 | 13 | 2 | B | PRESENT INVENTION |
| 36 | 13 | 3 | B | PRESENT INVENTION |
| 37 | 15 | 1 | A | PRESENT INVENTION |
| 38 | 15 | 2 | A | PRESENT INVENTION |
| 39 | 15 | 3 | A | PRESENT INVENTION |
| 40 | 16 | 1 | B | PRESENT INVENTION |
| 41 | 16 | 2 | B | PRESENT INVENTION |
| 42 | 16 | 3 | B | PRESENT INVENTION |
| 43 | 17 | 1 | A | PRESENT INVENTION |
| 44 | 17 | 2 | A | PRESENT INVENTION |
| 45 | 17 | 3 | A | PRESENT INVENTION |
| 46 | 22 | 1 | A | PRESENT INVENTION |
| 47 | 22 | 2 | A | PRESENT INVENTION |
| 48 | 22 | 3 | A | PRESENT INVENTION |
| 49 | 25 | 1 | A | PRESENT INVENTION |
| 50 | 25 | 2 | A | PRESENT INVENTION |
| 51 | 25 | 3 | A | PRESENT INVENTION |
| 52 | 29 | 1 | A | PRESENT INVENTION |
| 53 | 29 | 2 | A | PRESENT INVENTION |
| 54 | 29 | 3 | A | PRESENT INVENTION |
| 55 | 34 | 1 | D | COMPARATIVE EXAMPLE |
| 56 | 34 | 2 | D | COMPARATIVE EXAMPLE |
| 57 | 34 | 3 | D | COMPARATIVE EXAMPLE |
| 58 | 35 | 1 | C | COMPARATIVE EXAMPLE |
| 59 | 35 | 2 | C | COMPARATIVE EXAMPLE |
| 60 | 35 | 3 | C | COMPARATIVE EXAMPLE |

From the results shown in Tables IX and X, it is understood that the near-infrared light absorbing cured film of the present invention is excellent in moist/heat resistance.

From the above results, it can be confirmed that the near-infrared light absorbing composition of the present invention has excellent storage stability and can form a cured film having excellent moist/heat resistance.

### INDUSTRIAL APPLICABILITY

The present invention can be used for a near-infrared light absorbing composition, a near-infrared light absorbing cured film, and an optical member.

### REFERENCE SIGNS LIST

1 camera module
2 adhesive
3 glass substrate
4 imaging lens
5 lens holder
6 light shielding and electromagnetic shield
7 adhesive
8 planarization layer
9 near-infrared light cut filter
10 solid state imaging device substrate
11 solder ball
12 circuit board
14 solid state imaging device image sensor
21 transparent dielectric substrate
22 near-infrared light absorbing layer
23 dielectric multilayer film

1. A near-infrared light absorbing composition comprising the following components (A) to (E):
(A) component: A copper complex coordinated with a compound having a structure represented by the following General Formula (I).
[Chemical Formula 1] 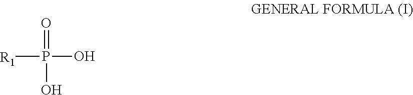
[In the General Formula (I), R₁ is an alkyl group having 1 to 20 carbon atoms and may further have a substituent group.]
(B) component: A compound having a structure represented by the following General Formula (II):
[Chemical Formula 2] 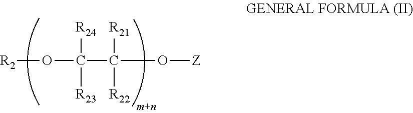
[In the General Formula (II), R₂ is an alkyl group having 1 to 20 carbon atoms or an aryl group having 6 to 20 carbon atoms, and may further have a substituent group. R₂₁ to R₂₄ each independently represents a hydrogen atom or an alkyl group having 1 to 4 carbon atoms. m represents an average addition number of a partial structural unit in which all of R₂₁ to R₂₄ are hydrogen atoms, and is in a range of 0 to 19. n represents an average addition number of a partial structural unit in which at least one of R₂₁ to R₂₄ is an alkyl group having 1 to 4 carbon atoms, and is in a range of 0 to 19. m+n represents a total number of m and n, and is in a range of 1 to 20. Z represents a structural unit selected from, the following formulas (Z-1) and (Z-2).]
[Chemical Formula 3] 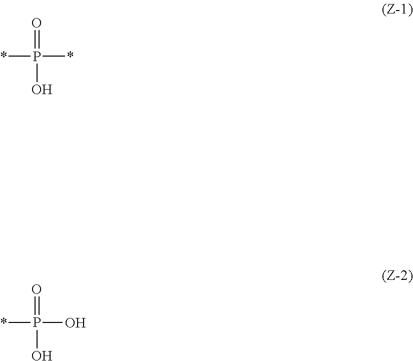 [SMILES: *P(*)(=O)O ; *P(=O)(O)O]
(C) component: A compound having a structure represented by the following General Formula (III) or (IV):
(R₃O)₄₋ₘTi(O—R₄—OH)ₘ General Formula (III)
(R₃O)₄₋ₘTi(OCOR₅)ₘ General Formula (IV)
[In the General Formulas (III) and (IV), m is an integer of 1 to 4. R₄ is an alkylene group having 1 to 30 carbon atoms, and may further have the substituent group. R₃ and R₅ are each the independent alkyl group having 1 to 30 carbon atoms, and may further have the substituent group.]
(D) component: A compound having a structure represented by the following General Formula (V):
R₆—(CH₂)ₘ—Si(CH₃)ₙ—(OR₇)₃₋ₙ General Formula (V)
[In the General Formula (V), R₆ represents a vinyl group, styryl group, acryloxy group, methacryloxy group, mercapto group, epoxy group, epoxycyclohexyl group or glycidoxy group, and may further have the substituent group. R₇ is an alkyl group having 1 to 3 carbon atoms. m is an integer of 0 to 8. n is 0 or 1.]
(E) component: A solvent having a value of a polarity parameter δ_{P} of a Hansen Solubility Parameter within a range of 3 to 6 and a value of a hydrogen bonding parameter δ_{H} within a range of 3 to 6.

2. The near-infrared light absorbing composition according to claim 1, wherein the compound having a structure represented by the General Formula (II) simultaneously has at least one each of a partial structure satisfying the following condition (i) and a partial structure satisfying the following condition (ii),
Condition (i): R₂₁ to R₂₄ are all hydrogen atoms.
Condition (ii): At least one of R₂₁ to R₂₄ is an alkyl group having 1 to 4 carbon atoms.
and, wherein m and n in the General Formula (II) are each in a range of 1 to 19.

3. The near-infrared light absorbing composition according to claim 1, wherein a content of the (C) component is in a range of 1 to 30% by mass with respect to the (A) component.

4. The near-infrared light absorbing composition according to claim 1, wherein a content of the (D) component is in a range of 1 to 30% by mass with respect to the (A) component.

5. The near-infrared light absorbing composition according to claim 1, wherein R₆ in the general formula (V) is an acryloxy group or a methacryloxy group.

6. The near-infrared light absorbing composition according to claim 1, wherein the (E) component is cyclopentyl methyl ether or 4-methyltetrahydropyran.

7. A near-infrared light absorbing cured film comprising:
a cured product of the near-infrared light absorbing composition according to claim 1.

8. An optical member comprising:
a cured product of the near-infrared light absorbing composition according to claim 1.
